(19) United States
(12) Patent Application Publication
(10) Pub. No.: US 2006/0026431 A1
(43) Pub. Date: Feb. 2, 2006

(54) Cryptographic letterheads

(75) Inventor: Jorge Campello De Souza, Cupertino, CA (US)

Correspondence Address: Hitachi Global Storage Technologies, 5600 Cottle Road (NHGB/01), San Jose, CA, 95123, US

(73) Assignee: Hitachi Global Storage Technologies B.V., Amsterdam (NL)

(21) Appl. No.: 10/903,434

(22) Filed: Jul. 30, 2004

(51) Int. Cl. H04L 9/00

(52) U.S. Cl. 713/176

(57) ABSTRACT

Digital watermark data is embedded into compressed media content that is transmarked when the compressed media content is converted to an analog format or into an uncompressed digital format. The watermark data uniquely identifies the converter/player device/user that converted the watermark-protected digital media content into the analog format or the uncompressed digital format. The presented media content in the analog format or the uncompressed digital format is modified as a function of the watermark data and the digital signature obtained from the converter/player device/user. The modifications are visible and essentially produce a correspondingly different media presentation for each converter/player device/user. The modifications, however, are selected so that they are nonessential to the storyline and, consequently, not noticed by a casual user.

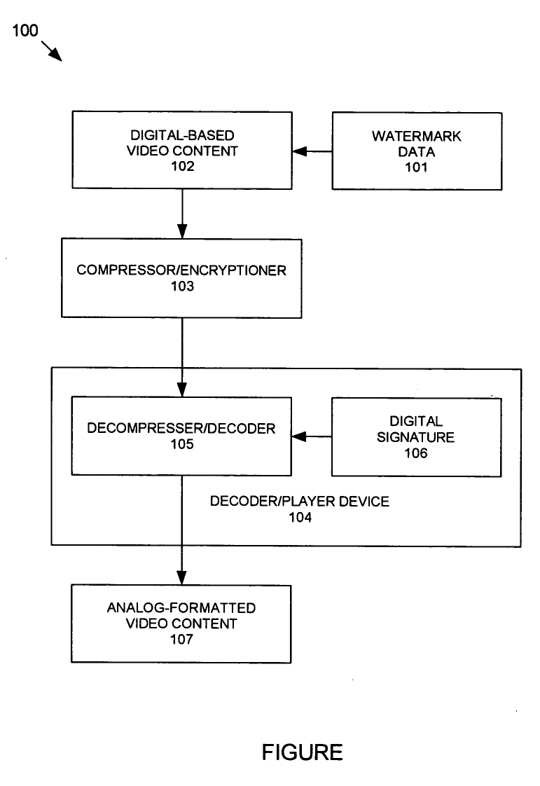

### BACKGROUND OF THE INVENTION

1. Field of the Invention

The present invention relates to digital watermarks. More particularly, the present invention relates to a system and a method for embedding a digital watermark that uniquely identifies the converter/player that converts protected, compressed digital content into an analog format or into an uncompressed digital format.

2. Description of the Related Art

Digital compression techniques, such as MPEG-type compression techniques, are used for storing video and/or audio content as units of aural, visual or audiovisual content referred to as “media objects.” A process referred to as “composition” is used to create compound media objects from individual media objects by including information in an MPEG file relating to arrangements and relationships between individual media objects, such as temporal, special hierarchies of layers, etc. arrangements and relationship, and thereby create final audiovisual scenes.

In order to prevent unauthorized copying and distribution of content, digital watermarks have been used in connection with Digital Rights Management (DRM) systems. The watermarks are embedded into the content (not into a header portion) which electronic devices can read, but which humans cannot perceive and, thus, do not reduce the entertainment value of the content. There are two primary types of watermarks that have been used: watermarks that try to communicate DRM information to the capture device and watermarks that try to embed information about the player/user into the content. The latter type of watermark is referred as a forensic watermark.

The content can be delivered to a user's player in a secure fashion by, for example, using a Public Key Infrastructure (PKI) to uniquely identify the player, generate a session key and then use the section key to encrypt the content for delivery only to that player. After the data has been decrypted, decompressed and delivered in an analog format, however, the DRM system cannot control the content and the content can be digitized into an uncontrolled digital format that can be freely copied and distributed over the Internet. When a digital television set is used, the display itself functions as a digital-to-analog converter. This problem is commonly referred to as “the analog hole.”

A digital watermark as a countermeasure against unauthorized copying and redistribution of video content is inherently difficult to implement and not particularly robust when the content that is to be protected must be converted to an unprotected format for consumption. That is, in order to serve as content protection purposes, a watermark must survive digitization and compression, such as MPEG-type encoding and decoding. Video compression technologies, such as MPEG-type encoding, are designed, however, to only encode the portion of the video content that humans can perceive, and eliminate everything else from the content.

Consequently, what is needed is a transmarking technique for embedding a digital watermark that uniquely and unequivocally identifies the converter/player/user that converts protected, compressed digital content into an analog format or into an uncompressed digital format.

### BRIEF SUMMARY OF THE INVENTION

The present invention provides a transmarking technique for embedding a forensic-type digital watermark that uniquely and unequivocally identifies the converter/player/user that converts protected, compressed digital content into an analog format or into an uncompressed digital format.

The advantages of the present invention are provided by a system and a method for watermarking media content that includes video content in which a digitizer digitizes the media content. A watermark inserter inserts watermark data into the media content. The watermark data relates to at least one of a type of a media object, a property of a media object, a movement of a media object, a location of a media object, a quantity of a media object, a scene duration and a scene sequence and causes the media content to exhibit at least one of a corresponding media object, property of a media object, a movement of a media object, a location of a media object, a quantity of a media object, a scene duration and scene sequence based on the watermark data and the identification information of a decoder when the media content is decoded. The system also includes a compressor that compresses the media content containing the inserted watermark data based on, for example, an MPEG compression standard, such as an MPEG-4 compression technique. When a decoder decodes the media content in a tamper-resistant environment, the decoder inserts at least one of a type of a media object, a property of a media object, a movement of a media object, a location of a media object, a quantity of a media object, a scene duration and a scene sequence into the media content corresponding to the watermark data and the identification information of the decoder/user. The identification information of the decoder/user can include at least one of a digital signature of the decoder/user, an identifier of the decoder/user, a user access certificate, a user license, an identification number of a processor of the decoder, and a MAC address associated with the decoder/user.

### BRIEF DESCRIPTION OF THE DRAWINGS

The present invention is illustrated by way of example and not by limitation in the accompanying sole Figure that depicts a functional block diagram of a system that provides a transmarking technique according to the present invention.

### DETAILED DESCRIPTION OF THE INVENTION

The present invention provides a technique that embeds a forensic-type digital watermark data into compressed media content and transmarks the watermark data to an analog format or into an uncompressed digital format when the media content is converted to the analog format or the uncompressed digital format. The watermark data uniquely and unequivocally identifies the converter/player device/user that converted the watermark-protected digital media content into the analog format or the uncompressed digital format. The presented media content in the analog format or the uncompressed digital format is modified as a function of the watermark data and the digital signature obtained from the converter/player device/user, and is readily implemented using MPEG-4 scene description language. The modifications are visible and essentially produce a correspondingly different media production for each converter/player device/user. The modifications, however, are selected so that they are nonessential to the storyline and, consequently, not noticed by a casual user.

Moreover, the modifications provided by the present invention have the property of being visible and, consequently, will survive digitization and compression, such as MPEG-type encoding. That is, decompression, digital-to-analog conversion, analog-to-digital conversion, and then compression. In that regard, the present invention provides an embedded signature that withstands digitization followed by strong compression, any cropping, distortion or filtering that may be applied, in addition to repeated re-compression operations.

The embedded watermark data can relate to several different mechanisms, such as types or kinds of (visible) objects, properties of objects, object movement, object location, quantity of objects, scene duration and/or scene sequence. An ornamental object, such as a knickknack-type item, is an example of an object that can appear to be placed on a shelf or table in a scene as a function of the digital signature of the converter/player device/user. Other types of objects that could be used include items such as a vase, a picture, an ashtray, a bowl, an aquarium, a book and/or a plant.

Object properties that can be varied include the size, color, orientation and/or texture. For example, the characteristics of a vase, such as the hue of the color of the vase, the shape of the vase, the orientation of the vase, could be varied based on the digital signature of the converter/player device/user. Object movement, such as trajectories, range of motion and/or duration of motion, could change as a function of the digital signature of the converter/player device/user. For example, a spaceship entry and exit points on the screen during a battle scene of a sci-fi video content can be varied based on the digital signature of the converter/player/device/user.

The position of objects within a scene is a particularly effective technique for embedding information into the media content without changing the essence of the scene. The number of objects, such as the number of leaves in a tree or on a plant, the number of books on a bookshelf, the number of items in a background pattern, the number of chairs around a table, etc., can all be varied based on the digital signature of the converter/player device/user. The duration and sequence of scenes can be varied without affecting the storyline of media content based on the digital signature of the converter/player/device/user.

Other information that could be contained in the watermark data includes, for example, content provider identification, i.e., copyright notice, licensing terms for content, name of licensee, geographic area, dates, etc.

The sole Figure depicts a functional block diagram of a system 100 that provides a transmarking technique according to the present invention. Watermark data 101 is embedded into digital-based media content 102 in a well-known manner. Media content 102 can include, but is not limited to, audio/video content, such as real-life-like movies and animated features, like cartoons, and still images. Watermark data 101 contains information relating to types or kinds of (visible) objects, properties of objects, object movement, object location, quantity of objects, scene duration and/or scene sequence that can be varied as a function of the digital signature of a decoder/player device/user. Media content 102 is then compressed and/or encrypted by compressor/encrypter 103 in a well-known manner, such as by one of the MPEG compression techniques. For example, compressor/encrypter 103 can be based on the MPEG-4 and its scene description language.

No person should have access to compressed/encrypted media content 103 after it has been decrypted, but before watermark data 101 has been inserted and the signal decompressed. Delivery of compressed/encrypted media content 103 to decoder/player 104 must also be controlled so that compressed/encrypted media content 103 cannot be tampered with before reaching decoder player 104. Subsequently, compressed/encrypted media content 103 is decompressed/decoded by decoder/player device 104, which can be, for example, a set-top terminal, a Digital Video Disc (DVD) player, a digital-to-analog converter (DAC) or a video card in a personal computer (PC). A decompresser/decoder 105 uses the digital signature 106 of decoder/player device 104 to generate an analog-based media content 107. Additionally, or in the alternative, decompresser/decoder 105 could use an identifier of the decoder/user, a user access certificate, a user license, an identification number of a CPU, and/or a MAC address associated with decoder/player device 104 or the user to generate analog-based content 107. It is important that decompresser/decoder 105 and digital signature module 106 be contained within a tamper-resistant module.

Images contained in analog-based media content 107 differ from analog-based media content decompressed/decoded by other decoder/player devices/users. For example, consider a video content scene that is focused on a teddy bear that is positioned on one shelf of a bookshelf having several shelves. Any modifications to items on the shelves of the bookshelf are non-essential to the storyline associated with the teddy bear. Accordingly, the background provided by the bookshelf and the items on the bookshelf are selected to be artificially very busy to facilitate the transmarking of the present invention. When watermark data embedded by the present invention relates to the appearance/nonappearance of, for example, four specific objects on the shelves, and in which any combination of the four specific objects could be visible at any time; four bits of information would be embedded in the scene.

When the embedded watermark data relates to the arrangement of books on the shelves and, for example, the bookshelf holds approximately 70 books, then there would be log₂(70!) embedded bits, or approximately 332 bits, of watermark data if the order of the books could be any permutation. If an object sitting on, for example, the bottom shelf could be placed into any one of 16 possible positions on the shelf, then four bits of watermark data have been embedded.

The scene modifications of the present invention could alternatively be based on, for example, a scene that has been filmed by the director in a number of different ways. In yet another exemplary embodiment of the present invention, scene modifications can be provided based on post-production and editing operations.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for watermarking media content, comprising:
a digitizer digitizing the media content; and
a watermark inserter inserting watermark data into the media content, the watermark data relating to at least one of a type of a media object, a property of a media object, a movement of a media object, a location of a media object, a quantity of a media object, a scene duration and a scene sequence and causing the media content to exhibit at least one of a corresponding media object, property of a media object, a movement of a media object, a location of a media object, a quantity of a media object, a scene duration and scene sequence based on the watermark data and identification information of one of a decoder and a user when the media content is decoded.

2. The system according to claim 1, further comprising a compressor compressing the media content containing the inserted watermark data.

3. The system according to claim 2, wherein the compressor compresses the media content based on an MPEG compression standard.

4. The system according to claim 3, wherein the MPEG compression standard is an MPEG-4 compression technique.

5. The system according to claim 1, wherein the media content includes video content.

6. The system according to claim 1, further comprising:
a decoder decoding the media content, the decoder inserting into the decoded media content at least one of a type of a media object, a property of a media object, a movement of a media object, a location of a media object, a quantity of a media object, a scene duration and a scene sequence corresponding to the watermark data and the identification information.

7. The system according to claim 6, wherein the identification information is at least one of a digital signature of the decoder, a digital signature of the user, an identifier of the decoder, an identifier of the user, a user access certificate, a user license, an identification number of a processor of the decoder, a MAC address associated with the decoder, and a MAC address associated with the user.

8. The system according to claim 6, wherein the decoder is part of a tamper-resistant module.

9. A system for watermarking media content, comprising:
media content containing watermark data relating to at least one of a type of a media object, a property of a media object, a movement of a media object, a location of a media object, a quantity of a media object, a scene duration and a scene sequence that causes the media content to exhibit at least one of a corresponding media object, property of a media object, a movement of a media object, a location of a media object, a quantity of a media object, a scene duration and scene sequence based on the watermark data and identification information of one of a decoder and a user when the media content is decoded; and
a decoder decoding the media content, the decoded media content exhibiting at least one of a corresponding media object, property of a media object, a movement of a media object, a location of a media object, a quantity of a media object, a scene duration and scene sequence based on the watermark data and the identification information.

10. The system according to claim 9, wherein the identification information is at least one of a digital signature of the decoder, a digital signature of the user, an identifier of the decoder, an identifier of the user, a user access certificate, a user license, an identification number of a processor of the decoder, a MAC address associated with the decoder and a MAC address associated with the user.

11. The system according to claim 9, wherein the decoder is part of a tamper-resistant module.

12. A method of watermarking media content, comprising:
providing digital-based media content; and
inserting watermark data into the media content, the watermark data relating to at least one of a type of a media object, a property of a media object, a movement of a media object, a location of a media object, a quantity of a media object, a scene duration and a scene sequence and causing the media content to exhibit at least one of a corresponding media object, property of a media object, a movement of a media object, a location of a media object, a quantity of a media object, a scene duration and scene sequence based on the watermark data and identification information of one of a decoder and a user when the media content is decoded.

13. The method according to claim 12, further comprising compressing the media content containing the inserted watermark data.

14. The method according to claim 13, wherein compressing the media content includes compressing the media content based on an MPEG compression standard.

15. The method according to claim 14, wherein the MPEG compression standard is an MPEG-4 compression technique.

16. The method according to claim 12, wherein the media content includes video content.

17. The method according to claim 12, further comprising:
decoding the media content; and
inserting into the decoded media content at least one of a type of a media object, a property of a media object, a movement of a media object, a location of a media object, a quantity of a media object, a scene duration and a scene sequence corresponding to the watermark data and the identification information.

18. The method according to claim 17, wherein the identification information is at least one of a digital signature of the decoder, a digital signature of a user, an identifier of the decoder, an identifier of a user, a user access certificate, a user license, an identification number of a processor of the decoder, a MAC address associated with the decoder and a MAC address associated with the user.

19. The method according to claim 17, wherein the decoding is performed in a tamper-resistant environment.

20. A method of watermarking media content, comprising:
providing the media content, the media content containing watermark data relating to at least one of a type of a media object, a property of a media object, a movement of a media object, a location of a media object, a quantity of a media object, a scene duration and a scene sequence that causes the media content to exhibit at least one of a corresponding media object, property of a media object, a movement of a media object, a location of a media object, a quantity of a media object, a scene duration and scene sequence based on the watermark data and identification information of one of a decoder and a user when the media content is decoded; and
decoding the media content, the decoded media content exhibiting at least one of a corresponding media object, property of a media object, a movement of a media object, a location of a media object, a quantity of a media object, a scene duration and scene sequence based on the watermark data and the identification information.

21. The method according to claim 20, wherein the identification information is at least one of a digital signature of the decoder, a digital signature of the user, an identifier of the decoder, an identifier of the user, a user access certificate, a user license, an identification number of a processor of the decoder, a MAC address associated with the decoder and a MAC address associated with the user.

22. The method according to claim 20, wherein the decoding is performed in a tamper-resistant environment.
